(19) United States
(12) Patent Application Publication
(10) Pub. No.: US 2008/0028964 A1
(43) Pub. Date: Feb. 7, 2008

(54) Mounting image carrying plate onto a cylinder

(76) Inventor: David A. McEachern, St. Paul, MN (US)

Correspondence Address: Marvin Jacobson;Jacobson and Johnson, Suite 285, One West Water Street, St. Paul, MN, 55107-2080, US

(21) Appl. No.: 11/498,342

(22) Filed: Aug. 4, 2006

(51) Int. Cl. B41F 27/00

(52) U.S. Cl. 101/383

(57) ABSTRACT

An image-carrying plate such as a printing plate, an embossing plate, a die-cutting plate or the like for reproducing the image on a suitable media is mounted on a rotatable cylinder or drum by attaching a removable clamp to each end of the plate and removably attaching the plate clamps respectively to clamp carriers which are circumferentially spaced from one another on the cylinder with the plate at least partially wrapped around the outer surface of the cylinder. At least one clamp carrier on the cylinder can be adjusted to move the associated plate clamp so that the plate is pulled taut against the outer surface of the cylinder.

### FIELD OF THE INVENTION

This invention is in the field of curved latches or holding devices in the form of a cylinder or drum in combination with an image-carrying plate removably mounted on the outer surface of the cylinder or drum for reproducing the image on a suitable media. More particularly, the invention is directed toward removably coupling the image-carrying plate to the cylinder by removably attaching clamps which are attached to each end of the image-carrying plate to clamp carriers which are circumferentially spaced from one another on the cylinder.

### DESCRIPTION OF THE PRIOR ART

U.S. Pat. No. 6,454,686 by McEachern describes a magnetic cylinder or drum which firmly holds in place a magnetically permeable image-carrying plate such as a printing plate, an embossing plate, a die-cutting plate or the like and the cylinder or drum is rotatably driven, usually at fairly high speeds, to reproduce or transfer the image on the image-carrying plate repeatedly to suitable image-receiving media. The magnetic holding field of the cylinder armatures with the magnetically permeable image-carrying plate to securely hold the plate in place as the cylinder is rotated and the plate repeatedly contacts the media to transfer the image. There are also machines used in the industry for printing, embossing or die-cutting or similar which do not use a magnetic cylinder and use mechanical clamps to secure the image-carrying plater onto the cylinder. It is not uncommon that in some applications it is necessary to repeatedly change the image-carrying plate especially when the system is being used to produce what is called short runs. Typically and conventionally it has been found that in those instances, instead of stopping the machine then removing the cylinder, then replacing the plate and then placing the same cylinder with the new plate back in the machine, it is more efficient to have a second cylinder on hand with the replacement plate mounted on the cylinder, then stopping the machine and removing the cylinder with its attached plate and replacing it with the second cylinder with its attached replacement plate. Some operators change plates by turning off the equipment and attaching the replacement plate onto the same cylinder without removing the cylinder. This can result in a significant amount of down time for the equipment.

In any event, it appears that it is simpler to attach and/or replace a magnetically permeable plate on a magnetic cylinder and locate and align it in proper registration than it is to attach a plate to a nonmagnetic cylinder. In the case of the latter, the normal and past practice has been to attach the ends of the plate onto respective clamps which are integral parts of the cylinder and then adjust the plate while mounted on the cylinder and the cylinder itself to bring the image into register with the previously imprinted or transferred image from a previously used plate. Even when first mounting the plate on a nonmagnetic cylinder generally a significant amount of handling of the plate is necessary just to attach it and to adjust it so that it is properly located on the cylinder. This often has resulted in smudging or even damaging the image-carrying surface of the plate so that it has to be cleaned or replaced or repaired.

### SUMMARY OF THE INVENTION

The present invention provides for having a clamp at each end, sometimes hereinafter referred to as the leading or trailing edge, of an image-carrying plate. Correspondingly, a plate cylinder has a pair of respective clamp carriers which are spaced circumferentially on the cylinder to accommodate the length of the plate. Registration or indexing apertures or openings at the leading and trailing edges of the plate are provided to mate with corresponding registration or indexing pins in the respective clamps. To attach the plate to a cylinder the plate is indexed and clamped at each end and then the plate clamps are grasped and attached to the respective clamp carriers on the cylinder so that the plate is virtually untouched in the area of the image-carrying surface in the process. As with present day equipment, means are provided on the cylinder to adjust one or both ends of the mounted plate circumferentially to pull the plate taut so it rests firmly against the surface of the rotatable cylinder.

### BRIEF DESCRIPTION OF THE DRAWINGS

FIG. 1 is an end perspective view of a cylinder illustrating an embodiment of the invention in use;

FIG. 2A is a top view of a jaw of a plate clamp as an element of an embodiment of the invention;

FIG. 2B is a top view of the other jaw of a plate clamp;

FIG. 2C is a side view of the plate clamp jaw illustrated in FIG. 2B;

FIG. 2D is an end view of FIG. 2B;

FIG. 3A is a top view of a clamp carrier utilized in an embodiment of the invention;

FIG. 3B is a front edge view of FIG. 3A;

FIG. 3C is an end view of FIG. 3A;

FIG. 4A is a plan view of a portion of an image-carrying plate;

FIG. 4B is a side edge view of FIG. 4A; and

FIG. 5 is a blow-apart illustration of an embodiment of the invention as attached to a cylinder.

### DESCRIPTION OF THE PREFERRED EMBODIMENTS

As illustrated in FIG. 1, an image-carrying plate 10 is wrapped at least partly around the outer surface of a cylinder 11 and attached to cylinder 11 by plate clamps 12 which are attached to the ends of plate 10. Clamps 12 are coupled to clamp carriers 13 which are located in grooves or recesses 32 (FIG. 5) in the outer surface of cylinder 11. Conventionally, cylinder 11 has a hollow core for mounting the cylinder onto a rotatably driven shaft, not shown. Conventionally the shaft is cantilevered and the cylinder is removed by sliding the cylinder off the end of the cantilevered shaft and then replaced with a substitute cylinder. Typically and conventionally the equipment has features, not shown, which allow for minor adjustment for registration of the cylinder with attached plate when the cylinder is placed on and attached to its shaft. The. cylinder is usually made of a metal and may be a magnetic or nonmagnetic cylinder. Usually if a magnetic cylinder is used then a magnetically permeable plate is used and held in place by the magnetic holding field of the cylinder armaturing with the magnetically peremeable plate without the need for clamps 12 or clamp carriers 13. However, there are occasions when a user might want to attach a nonmagnetically permeable plate to a magnetic cylinder and, as mentioned earlier, many machines use a nonmagnetic plate with a nonmagnetic cylinder. The present invention serves either or both of the latter arrangements. Cylinder 11 has outer access openings 15 to permit adjustment of the clamp carriers 13 to pull the plate taut against the outer surface of cylinder 11. U.S. Pat. No. 6,443,064 by McEachern illustrates and describes mechanisms and method for adjusting a cylinder mounted on a shaft for accurate registration.

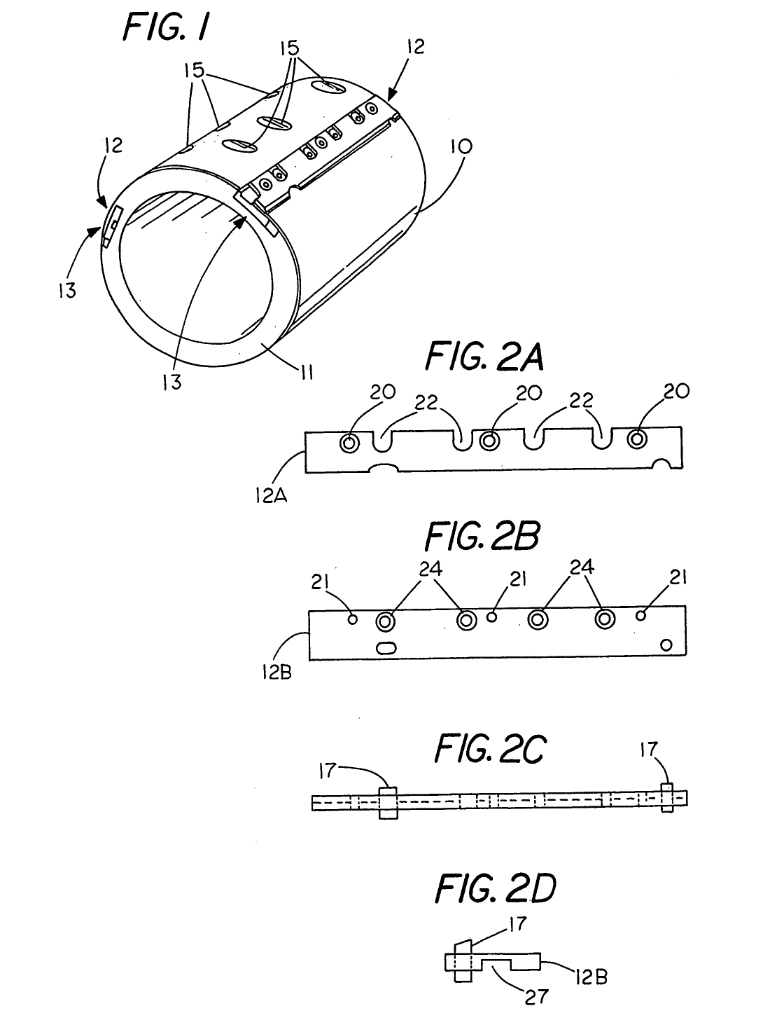

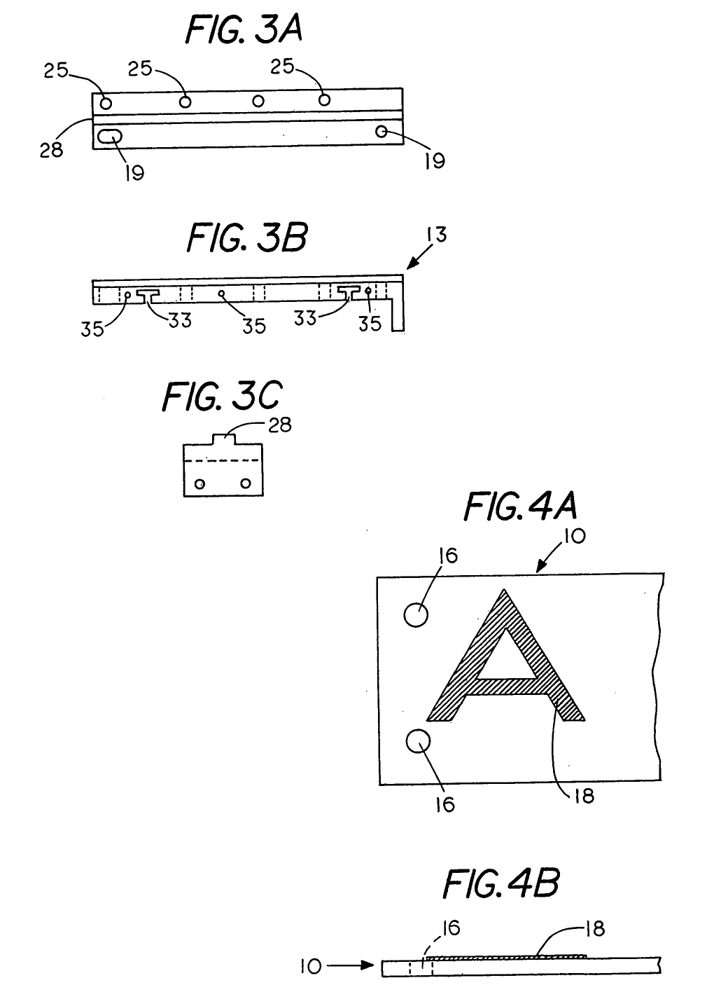

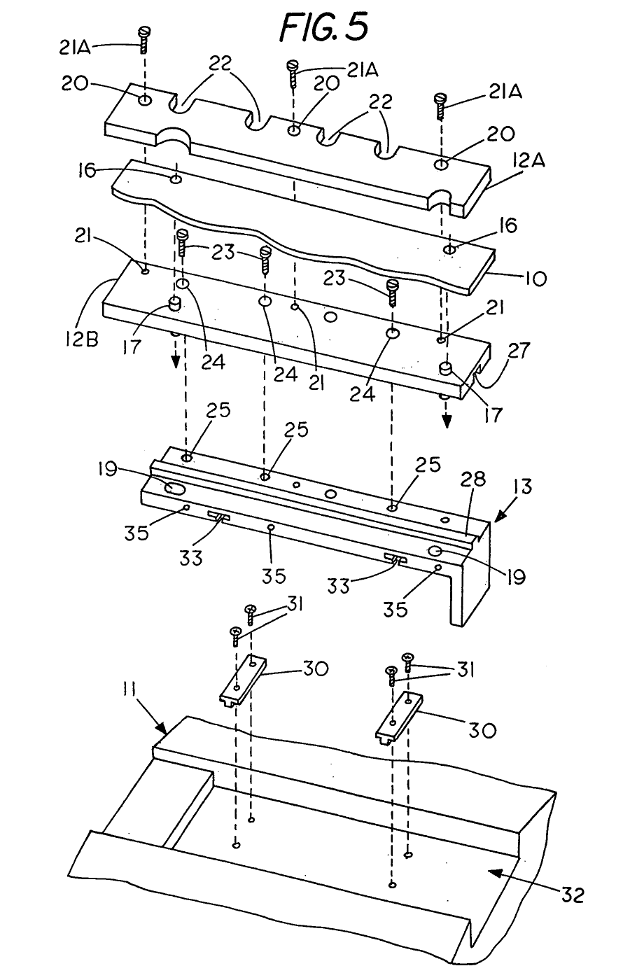

As illustrated more clearly in FIG. 4, typically an image-carrying plate 10 may be made out of a suitable material, such as aluminum for a non-magnetic plate or suitable metal for a magnetic plate, and thin enough so that it can be at least partially wrapped around the outside of the cylinder. The plate 10 has at least a pair of registration apertures or openings 16 at each end for engaging corresponding registration or indexing pins 17 (FIG. 2C) in plate clamps 12. The underside of plate 10, which rests against the cylinder surface, is usually smooth and unadorned and the upper or outer side carries an image 18 which is to be reproduced on or transferred to a suitable media, not shown. For illustration purposes only the image is shown as the letter “A” in block form.

Plate clamp 12, as illustrated in FIG. 2, comprises a pair of jaw members 12A and 12B. An end of plate 10 is clamped between the two jaw members with pins 17 engaging registration or indexing apertures 16. Jaw member 12A rests over jaw member 12B with the plate clamped therebetween and openings 20 on upper jaw member 12A are provided to accept threaded members 21A (FIG. 5) to engage threaded openings 21 on jaw member 12B to removably bring the two jaw members together firmly with an end of plate member 10 grasped firmly therebetween. Cutouts 22 in jaw member 12A are provided for access to threaded members 23 which extend through counter sunk openings 24 to engage threaded openings 25 for releasably attaching plate clamp 12 to clamp carrier 13. The underside of jaw 12B has a transverse recess or slot 27 for engaging a transverse raised section or rail 28 on clamp carrier 13. Also, pins 17 extend through jaw member 12B for engaging corresponding registration or indexing openings or recesses in clamp carrier 13.

As illustrated in FIG. 5, a pair of parallel T bars 30 are attached to cylinder 11 by threaded members 31 in the recess area generally designated by reference numeral 32. T bars 30 are engaged with T slots 33 on the underside of clamp carrier 13 so that clamp carrier 13 is movably engaged with cylinder 11 to permit circumferential adjustment, if needed, of plate 10 when mounted on the cylinder to permit the plate to be pulled taut so that it rests firmly against the outer surface of cylinder 11. As mentioned earlier and in conventional fashion, openings 15 are formed in cylinder 11 so that threaded adjustment members, not shown, can be inserted to engage threaded openings 35 located in the side of clamp carrier 13 and the adjustment members can be operated to move clamp carrier 13 circumferentially when plate clamps 12 with attached plate are coupled to clamp carrier 13 to ensure that plate 10 is pulled taut to rest firmly against the outside circumferential surface of cylinder 11.

In practice while one cylinder with attached image-carrying plate is in operation for transferring the image onto a media, another similar cylinder can be prepared to replace the cylinder in use with an image-carrying plate whose image likely must be registered with respect to the earlier transferred image. Each end of an image-carrying plate 10 is placed suitably between the clamping members or jaws 12A and 12B with the registration holes 16 engaged with the registration pins 17 and the clamp members secured together with threaded members 21A engaged in threaded openings 21.

Clamp carriers 13 are mounted in their respective recesses 32 on cylinder 11 with T bars 30 attached to the cylinder by threaded members 31 engaged in the tracks 33 on the underside of the clamp carrier 13.

The plate clamps 12 with plate 10 attached are then each placed on a corresponding clamp carrier 13 with the slot 27 engaging rail 28 and the underside of pins 17 engaging openings 19 in clamp carrier 13. Each plate clamp 12 is secured to its respective clamp carrier 13 with the respective threaded members 23 engaged in their respectively corresponding threaded openings 25. Only the plate clamps need be handled when mounting the plate onto the cylinder. Once mounted, if necessary, threaded adjustment members in openings 15 are engaged with threaded openings 35 on clamp carriers 13 and adjusted as necessary to move clamp carrier 13 to the degree necessary to pull the plate taut against the outer surface of the cylinder. Pins 17 and corresponding mating openings and/or recesses are machined or formed to quite close tolerances so that indexing or registration is very accurate.

The general practice is that when a plate is first mounted onto a cylinder as described hereinabove, the clamp carrier at one edge of the plate, usually the leading edge, locates that edge of the plate at an indexing location using conventional means and procedures, not shown or described. When the plate is replaced with another plate, as described hereinabove, the one clamp carrier locates that edge of the replacement plate at the indexing location and only the other clamp carrier is adjusted to pull the plate taut against the cylinder surface thereby insuring correct registration between the reproduced images of the respective plates. As mentioned earlier, generally the equipment is provided with features which allow for some minor adjustments if needed for more precise registration.

I claim:

1. A method for removably attaching an image carrying plate to a cylinder for rotatably transferring the image onto a suitable media, the method comprising the steps of:
a) securely clamping each end of the image carrying plate between the jaws of a plate clamp; then
b) removably attaching each of said plate clamps to a respective clamp carrier on the cylinder with the image carrying plate resting against the outer circumferential surface of the cylinder.

2. The method as described in claim 1 further including the step of:
adjusting at least one of the clamp carriers to bring the image carrying plate taut against the cylinder surface.

3. A method for removably attaching an image carrying plate to a cylinder for rotatably transferring the image onto a suitable media, the method comprising the steps of:
a) placing each end of an image-carrying plate between a pair of clamp members; then
b) releasably securely attaching the clamp members together to securely hold the ends of the plate; then
c) placing the clamps onto respective clamp carriers which are circumferentially spaced along the outer surface of a cylinder; then
d) releasably securing each of the clamps to a respective clamp carrier so that the plate is at least partly wrapped around and resting against the outer surface of the cylinder.

4. The method as described in claim 3 wherein step d) at least one clamp carrier is adjusted to pull the plate taut.

5. The method as described in claim 3 wherein step a) includes mating registration apertures in the plate with respectively corresponding registration pins on a plate clamp member.

6. Mechanism for attaching an image-carrying plate onto a rotatable cylinder used for rotatably repeatedly transferring the image on the plate onto a suitable media, said mechanism comprising:
a) a plate clamp attached to each end of an image-carrying plate, each plate clamp comprising a pair of jaw members releasably attached to one another with an end of the plate held firmly between said members;
b) one of said jaw members having a set of registration pins for engaging corresponding registration holes on said plate;
c) a pair of clamp carriers circumferentially spaced on the outer surface of said cylinder; and
d) means for removably coupling said plate clamps to respective ones of said clamp carriers.

7. The invention as described in claim 6 further including:
a) means on said cylinder engaged with said clamp carriers for circumferentially adjusting said clamp carriers when engaged with said plate clamps.

8. The invention as described in claim 6 wherein said means for removably coupling each of said plate clamps on its associated clamp carrier includes an elongated rail on one for engaging an elongated slot on the other.

9. The invention as described in claim 6 wherein said registration pins on said jaw members extend from said jaw members; and
said clamp carriers include regisration recesses for engaging the extended registration pins.

10. The invention as described in claim 9 wherein said registration pins and said clamp carrier registration recesses are formed with tight tolerances for accurate registration.
